(19) United States
(12) Patent Application Publication
(10) Pub. No.: US 2011/0029360 A1
(43) Pub. Date: Feb. 3, 2011

(54) SYSTEM AND METHOD FOR PROVIDING SMART PHONE FUNCTIONALITY FOR RETAILERS TO DISTRIBUTE SALE AND DISCOUNT COUPONS

(76) Inventor: Prasad Gollapalli, Reston, VA (US)

Correspondence Address: MCGUIREWOODS, LLP, 1750 TYSONS BLVD, SUITE 1800, MCLEAN, VA, 22102, US

(21) Appl. No.: 12/841,776

(22) Filed: Jul. 22, 2010

Related U.S. Application Data
(60) Provisional application No. 61/229,543, filed on Jul. 29, 2009.

(51) Int. Cl. G06Q 30/00; G01S 19/51; G06Q 99/00

(52) U.S. Cl. 705/14.1; 342/357.34; 705/346; 705/319

(57) ABSTRACT

A system and method for providing sale information including electronic coupons to a mobile wireless electronic device based on current location of the mobile wireless electronic device in relation to retail locations is described. The selection and communication of the sales information including electronic coupons to the mobile wireless electronic devices may also be made at least in part based on pre-defined preferences associated with a consumer associated with the mobile wireless electronic device.

This application claims benefit and priority to U.S. Provisional application No. 61/229,543, filed Jul. 29, 2009, the disclosure of which is incorporated by reference herein in its entirety.

### BACKGROUND OF THE INVENTION

1.0 Field of the Invention This invention generally relates to a system and method for providing Smart phone functionality and, more particularly, to a system and method for providing Smart phone functionality to enable retailers to distribute sale and discount coupons in a timely manner, perhaps based on the location of the customer and customer and/or retailer criteria.

2.0 Related Art

Shoppers often find it difficult to proactively plan and organize sales information before shopping trips, such as a grocery store for example. Often sales information is out-dated or sales items may be sold out by the time a shopping trip may actually occur. Once the shopper is inside the store, it may also be difficult to identify where sale items are located, especially if the shopper is pressed for time or distracted, such as with small children, for example.

Shoppers may be more interested to know about the most popular sale items in a particular geographic region and similarly, shoppers may be more interested in the sales that are suggested by friends and family. Currently, there is no easy way for shoppers to identify the most popular sale items or coupons or promotions offered by a retailer unless this information is posted on Facebook® or other websites of the retailer, for example. Even then, the information may be outdated. In the similar way, shoppers may have to email, call, text, or Facebook® or Twitter® (trademarks of respective owners) to notify friends and family about a particular sale. This word of mouth marketing carried by the loyal shoppers may be a valuable and low cost one that retailers may not totally benefit from without a proper medium. The few approaches that retailers try to use today are Facebook®, Twitter®, or the like, and other social network websites where they may encourage loyal customers to promote the retailer's sales. This may not totally generate the desired word of mouth marketing as most people are busy and may not have time to login the website or even check the website.

Moreover, retailers often find it difficult or costly to advertise sales or to provide coupons or redemption offers to potential customers efficiently. Printed coupons often have low success rates in reaching and/or getting the attention of potential customers. Also, retailers often want to reach specific types of customers with certain product buying patterns or behaviors, and targeting these customers with appropriate sales information and/or coupons may be beneficial.

Retailers may wish to aggregate sales information related to coupons and specific categories of customers in view of product types and/or seasons, and currently have limited methods of doing so. For example, sales of seasonal products may have different success rates based on types of coupons and types of customers, depending on seasons and geographic attractions.

A system and method for retailers to timely deliver targeted sales information and/or coupons with better awareness of consumer buying schedules or patterns, without relying solely on traditional printed material, would be beneficial to consumers and retailers, alike.

### SUMMARY OF THE INVENTION

The limitations in the prior art may be overcome by the improvements and advantages provided by the invention.

In one aspect, a system is provided that includes server that coordinates consumer location information with at least one location of one or more retail entities, at least one mobile wireless electronic device in communication with the server that is configured to provide the consumer location information and configured to receive sale promotions information for the one or more retail locations including electronic coupons, wherein the on-line website selects the sale promotions including electronic coupons based on the proximity of the mobile wireless electronic device to the one or more retail entities, and wherein the server is configured to provide a map of the one or more retail entities showing a location within the one or more retail entities of an item related to the electronic coupons.

In another aspect, a method of providing a sales promotion information service to mobile devices is provided. The method includes receiving a current location information from a mobile wireless electronic device, receiving sales information including electronic coupons from one or more retail entities, selecting sales information including an electronic coupon for at least one of the one or more retail entities based at least in part on the current location information and providing the sales information including the electronic coupon to the mobile wireless electronic device.

In another aspect, a method of providing sales information service to mobile devices is provided including receiving at a mobile device, coupon information related to an item for sale, receiving a map of a retail entity and displaying the map showing the location of the item within the entity.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1 is a block diagram of an embodiment of a system configured according to principles of the invention;

FIG. 2 is an illustration of a mobile electronic device showing a display of an exemplary bar code, according to principles of the invention;

FIG. 3 is a flow diagram of a process for performing the process when accessed by a consumer, the steps performed according to principles of the invention;

FIG. 4A is a flow diagram of a process for use by a retail entity, the steps performed according to principles of the invention;

FIG. 4B a flow diagram of a process for use by a service provider, the steps performed according to principles of the invention;

FIG. 5 illustrates a simple planogram showing aisles of a retail store and an item for sale, according to principles of the invention;

FIGS. 6A and 6B are flow diagrams showing steps of providing or receiving a planogram, the steps performed according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatuses, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

The system and method of the invention includes providing timely electronic sales information to potential consumers via their hand holdable electronic device such as, for example, a cell phone, a personal digital assistant (PDA), an iPhone® by Apple Inc., a Blackberry® device by Research In Motion, or other similar mobile electronic communication device suitable for personal portable usage. Timely sales information may be based on different factors such as inventory levels, manufacturer/supplier promotional incentives to the retailer, seasons, geography, local events (such as festivals, music productions, sports events, and the like), transient tourists, for example.

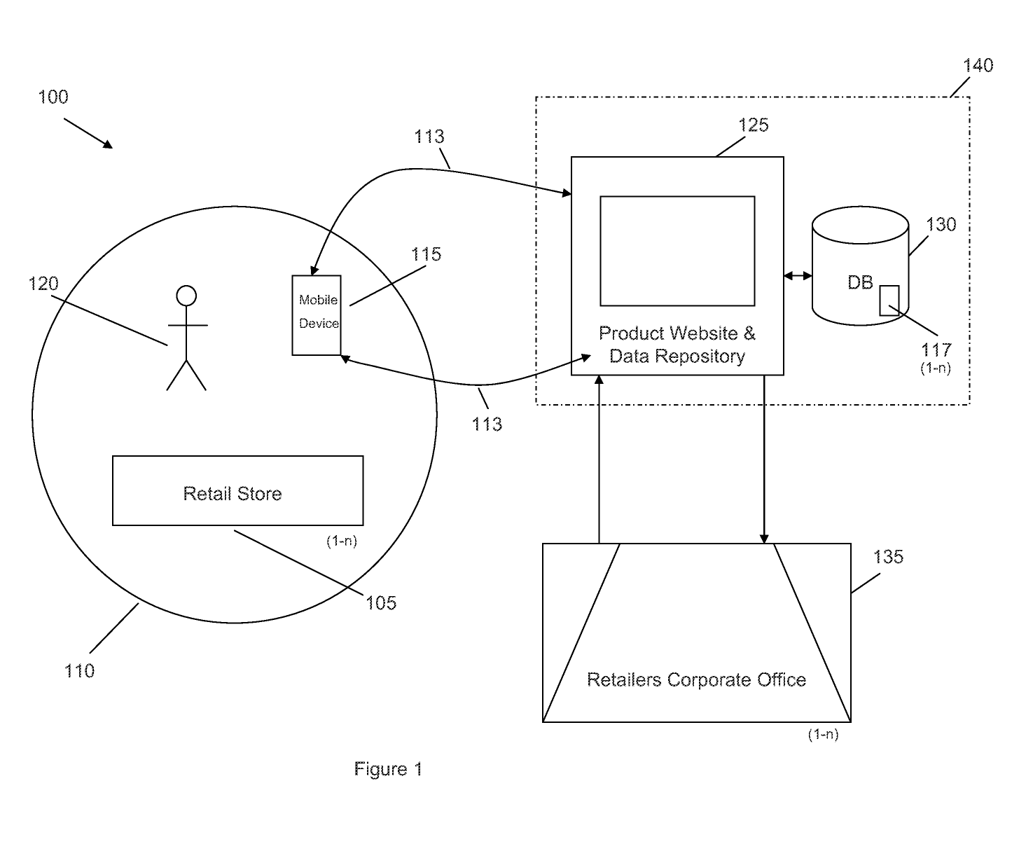

FIG. 1 is a block diagram of an embodiment of a system configured according to principles of the invention, generally denoted by reference numeral 100. A retail store 105 that sells products and may issue electronic sales information including electronic coupons to mobile wireless electronic device 115, such as a cell phone or the like, to permit a user 120 to view sales opportunities when in proximity 110 to a retail store 105. The user 110 of the mobile wireless electronic device 115 may maintain preferences 117, perhaps in a database 130 at a website 125 (or a server) of a service provider 140. The user 110 also may be a consumer herein. A retail corporate office 135, which could be corporate office operations of a retail chain for example, may maintain sales information and/or electronic coupons at the web site 125 of the service provider 140, and may tailor the electronic sales information to be targeted at select potential consumers or already known customers, perhaps based on composite sales information for specific geographic areas.

The mobile wireless electronic device 115 may communicate with the website 140 to obtain sales information and/or electronic coupons by way of a wireless network 113, perhaps including Evolution-Data Optimized (EDVO), for example. Other wireless communication techniques may be utilized, as is know in the art. The wireless device 115 may be equipped with GPS features for conveying location of the wireless device to the service provider 140.

The system 100 may provide to the user 120 via mobile wireless electronic device 115 information and/or coupons electronically when a user is proximate a retail store 105, as conveyed by GPS coordinates. When the user with the mobile wireless electronic device 115 is proximate 110 the retail store 105, communication with the web site may result in a search of the user's preferences 117 with the web site, perhaps resulting in any relevant sales information and/or electronic coupons to the mobile wireless electronic device 115.

Proximity parameters may also be established by the user 120 and/or by the service provider 140 so that a definition of what types of stores (sporting goods store, grocery store, clothing store, discount store, restaurant, fast food, etc.) and how close the user must be to the retail store, e.g., 1 mile, 2 miles, 300 yards, etc. Alternatively, in another aspect, the user may establish preferences that result in sales information and/coupons to be delivered without being proximate to the retail store 105, but related to the consumer's choice of product categories. Moreover, the user may plot a trip from a first location to a destination location and have a list of retail stores along the route being compiled and displayed, which may include sales promotions and/or coupons.

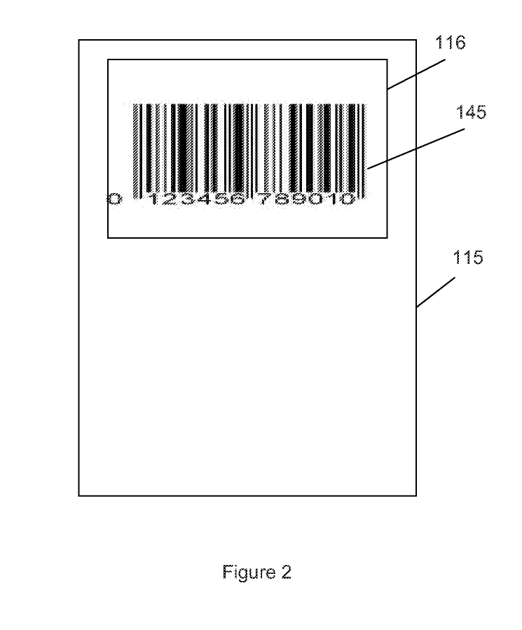

FIG. 2 is an illustration of a mobile electronic device showing a display of an exemplary bar code, according to principles of the invention. The mobile electronic device 115 is shown with a display 116 displaying an exemplary bar code 145 for use as a coupon at the time of check-out at a retail store. The bar code may be scanned at the check-out. Other promotions and product information also may be displayed. If more than one coupon may apply for a particular retail store, then a plurality of coupons may be display in sequence as appropriate for scanning.

A consumer with a mobile wireless electronic device 115 may be able to scan a list of possible products that may have an associated coupon(s), while in or near a store (or possibly even before being near a store). In this way, a consumer can judge if the promotion(s) are deemed desirable. Also, the lists may also be generated for more than one retail store for comparison of sales promotions between two stores. In this way, a consumer might plan their time more efficiently, or even decide that a particular retail store is better than another for spending his/her time and resources.

The system and method may include one or more of the following:
Automatic delivery of sales or coupon information to the consumer's mobile wireless electronic device when the consumer is near the retail store.
Ability to accurately record and eventually generate the aggregated market reports on consumers' shopping trends to help consumers and retailers plan appropriate sales.
Potentially significantly reducing the cost of advertising a sale but also targeting the sale to customers based on their specific preferences.
Permit dynamic sales promotion(s) when a potential consumer with certain preferences is proximate a retail store, and perhaps based on retail store inventory levels.

Retailers and distributors may benefit by:
Reducing costs of distributing sale information and coupons to potential customers.
Enabling retailers to create new sales and coupons on the fly based on market trends and potentially inventory levels, giving better control for managing individual stores.
Gathering valuable and accurate market information related to customers' shopping trends across various stores.
Creating cross-marketing coupons with other retailers in proximity to one another.

Consumers may benefit by:
More convenient sales information and coupons delivered electronically to their mobile wireless electronic device when the consumer is proximate a particular store, eliminating the need to preplan/gather their coupons and perhaps shopping lists.
No lost coupons and “maintain” only valid coupons that are unexpired.
Reduces paper waste as consumers may get their sales information and coupons electronically.
Consumers may be better able to control getting those offers for which they have set preferences. This may reduce unwanted solicitations of unwanted promotions.

A retailer may maintain sale information and coupons on the service provider website 125 (or, a server, which may or may not comprise a website) and revise such offerings based on various criteria such as, for example, inventory levels, time of month, geographic locations of consumers, demographics, time-of year, travel routes such as highways that might be bearing specific type of travelers (e.g., near a beach area, coupons related to restaurants or beach items, etc.), distributor promotions, cross-selling opportunities, close-out sales, and the like. All these may be compared with specific consumer preferences 117 to generate specific offers for individual consumers.

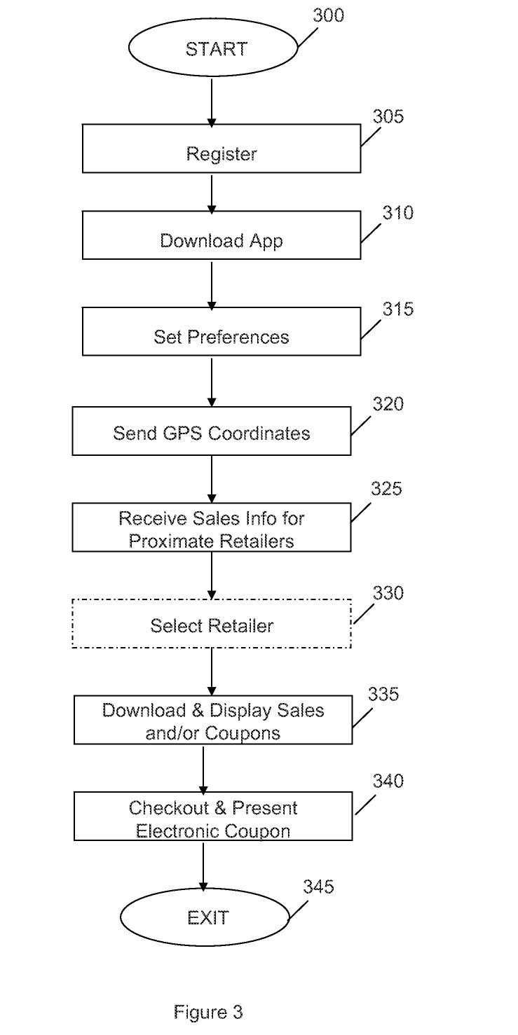

FIG. 3 is a flow diagram of a process for performing the process when accessed by a consumer, the steps performed according to principles of the invention, starting at step 300. FIG. 3 and all other flow charts herein may also represent block diagrams of components for performing the respective steps. The components may be hardware, hardware/software, or software that when configured to execute according to the principles of the invention cause the respective step to be performed. The software may be stored in a memory such as RAM and/or ROM, and/or it may be stored on a type of disc (DVD or CD), and when executed by a suitable processor performs the steps. The mobile wireless electronic device may be configured to execute certain steps using a processor and memory complex suitable for potable operations that may be low powered and complies with one or more various standards known in the telecommunications industry for use in mobile communications devices. The processors and programming languages may be different for the mobile wireless electronic device versus the service provider's web site platform since the scale may be different and processing power requirements may differ.

At step 305, a consumer/user may register and create an account with a “coupon service provider” (e.g., service provider 140). At step 310, the consumer/user may download a software based coupon application (“app”) that executes on the consumer's mobile wireless electronic device (such as device 115) and the app may be configured to communicate with the service provider, display menus, receive input for setting preferences, choosing coupons, processing coupons, and generally interacting with the web site 125. At step 315, the consumer/user may set preferences that indicate the type of products, stores, locations, and the like. The preferences may be communicated to the web site for establishing and recording the preferences.

At step 320, GPS coordinates may be conveyed the service provider so that a search may be conducted dynamically to identify any retail stores with promotions and/or coupons proximate the consumer/user, based on consumer/user preferences. At step 325, sales information and/or coupons may be received by the mobile wireless electronic device associated with the consumer/user. At optional step 330, the user may select a retailer, if more than one retailer is presented/available in the proximity area. At step 335, sales information and/or coupons may be downloaded to the mobile wireless electronic device. At step 340, the consumer/user may present the coupons or other promotional material during checkout. At step 345, the process may exit.

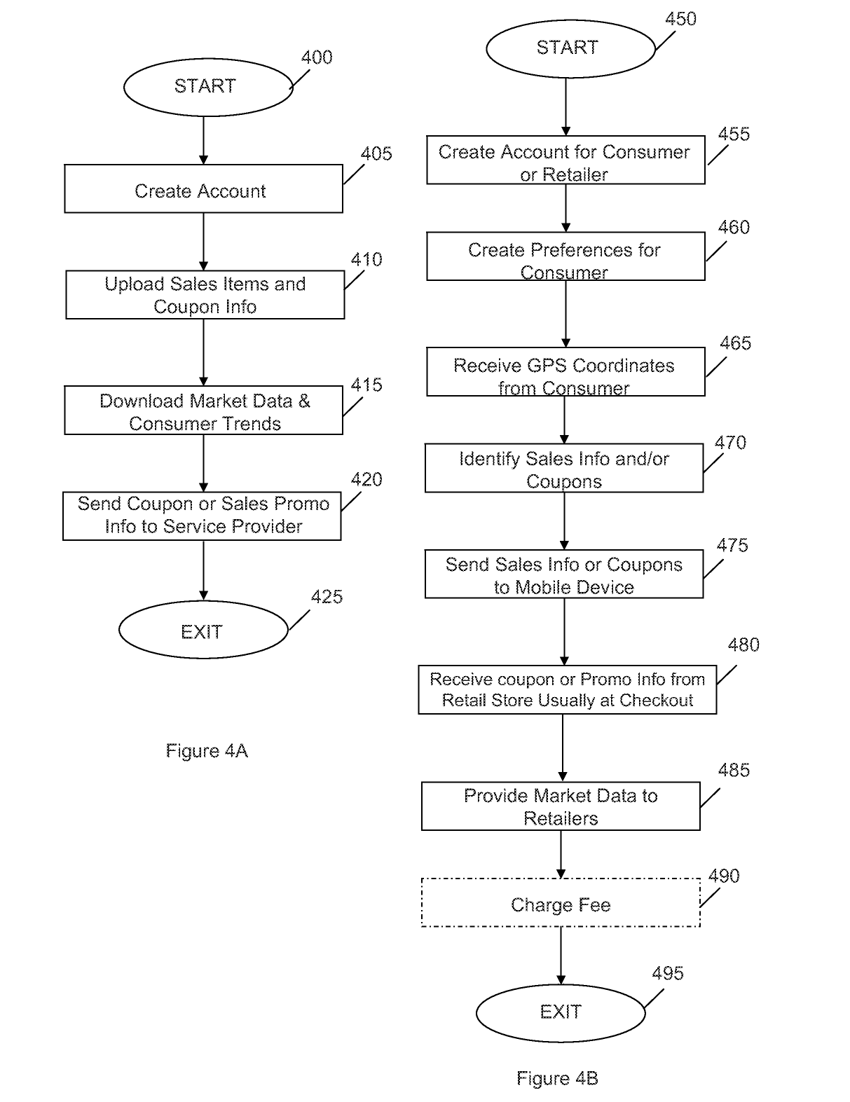

FIG. 4A is a flow diagram of a process for use by a retail entity, the steps performed according to principles of the invention, starting at step 400. At step 405, the retail entity may create an account with the on-line service provider (e.g., service provider 140), including retail entity location(s) (e.g., GPS locations of one or more retail stores) and product types. At step 410, the retail entity may upload sales information, sales promotions and/or coupons to the service provider. At step 415, the retail entity may download market data and consumer trends as compiled by the service provider based on consumer usage of the website and activity by its registered customers. At step 420, send coupon or sales promotion information usually, but not necessarily, at check-out time for a consumer to the service provider for processing the coupon or accounting for the use of the promotion information, perhaps cancelling or voiding the coupon for a second use, for example. At step 425, the process may exit.

FIG. 4B a flow diagram of a process for use by a service provider, the steps performed according to principles of the invention, starting at step 450. At step 455, an account may be created for either a new customer, which may be either a new consumer or a new retail entity. If for a new consumer, identification of the corresponding mobile wireless electronic device may be conveyed. At step 460, preferences may be created (or revised) for each consumer; the preferences (such as preferences 117) may include such criteria as type(s) of products, type(s) of stores, locations of stores, parameter(s) for setting proximity limits, and the like. This preference information may be maintained by the service provider in a database (e.g., DB 130). At step 465, the service provider may receive GPS coordinates from a specific mobile wireless electronic device and perform a search for any retailers proximate the specific mobile wireless electronic device. At step 470, any sales or coupons information may be identified for any proximate retailers based on the preferences associated with the consumer account of the specific mobile wireless electronic device. At step 475, the sales information and/or electronic coupons may be sent to the specific mobile wireless electronic device. At step 480, the service provider may receive at the web site, coupon or promotional information from a retail store usually, but not necessarily, at the time of checkout and may include identifying information of the customer, so that the coupon or promotional information may be accounted for such as voiding the coupon to prevent a second use, for example. At step 485, market data (perhaps aggregated by consumer, store, and/or product) may be provided to the retailer(s) perhaps including characteristics of consumer behavior. The data may include aggregated market data and may include demographic detailing. At optional step 490, a fee for subscription and/or any part of the service may be charged to a retailer and/or a consumer. At step 495, the process may end.

Shoppers usually get interested in the same sales and coupons that most other shoppers like. For this reason, shoppers may like to know about the most popular sales or coupons offered by any retailer. For the retailers, it may be difficult to communicate in real time the most popular sales (e.g., a sale item such as Diet Coke 12 pack for $1.99, for example) or coupons to shoppers as it takes time to compile all the sales data from the check out registers.

Prior to the invention, retailers either used social network sites or service such as Facebook® or Twitter® to get shoppers discussing the sales or coupons offered by the retailer. Further, they might use a blog on their website or other popular sites to get shoppers engaged in a conversation to rate the most popular sales or coupons. In addition to these approaches, the retailer might advertise the historical trends based on the actual data collected from the check out registers to advertise the most popular sales or coupons to the shoppers. Finally, the shopper might declare a particular sale the most popular by allocating the center spot in the weekly circular or by putting a big marketing sign such as a display banner, for example, in the store. These approaches may have inherent problems, such as, for example:
1. Shoppers have to actively participate and rate the sales or coupons
2. The rating declared by the retailer may be based on historical data and may not reflect the current trend, and
3. Further, the retailer may not be able to get historical data on the newly opened stores in new locations (such as new neighborhoods).

However, with the smart phone application, per principles of the invention, as customers add sales and coupons to their favorites or shopping list, the system such as at a server, may keep track and compile the most popular list. This list may be a real time list and specific to any particular retailer and further, particular to a store location or geographical region. This eliminates the above problems as it may not require the shopper to manually go to retailer's blog or Facebook® or Twitter® (trademarks of respective owners) pages to rate a sale or coupon. Hence this solution may be very convenient to the shoppers. Second, since this may be calculated in real time, shoppers may be able to see the true value of the most popular list. Finally, if the retailer opened a new store in a new location, the most popular list may still be constructed as it is compiled from the customers who are looking at the sales and coupons at that new location—no history would be needed.

In another aspect, retailers may want their loyal customers to promote the sales and coupons using “word of mouth” advertising. This word of mouth advertising may be hard as the loyal customers may have to use email, text, call, Facebook®, or the like, to spread the word on a popular sale item or coupons offered by a retailer. Second, these methods usually take time and by the time the other shoppers respond to the sale or coupon, it may be too late. Hence, it could end up in a disappointment.

With the Smart phone application implemented per principles of the invention, when a shopper adds a sale item or coupon to their favorite or shopping list, the shopper may simply notify the system to post that information (i.e., sale item or coupon) on their social network sites such as Facebook® or Twitter®, for example, and the Smart phone application system may automatically post that information in a presentable format to the shopper's social network sites. This makes it easy and fast for the shopper to spread the word on the sale and promotions offered by the retailer. Since these promotions may be posted quickly and in a consistent and more presentable format, they would catch other shoppers' attentions quickly, thereby allowing the shoppers to take better advantage of the sales or promotions and, thereby, enhancing the benefit of the word-of-mouth advertisements.

Most of the time, shoppers see the sales or promotions offered by a retailer and may get interested in them. Prior to the invention, there are at least two unique challenges faced by the shoppers generally:
1. They have to make a list of the sale items they want to purchase, and
2. Once they reach the store, they must navigate the aisles to find these sale items.

Currently, shoppers make shopping lists on a paper or cut and carry the sales circular or coupons with them to the store. Second, once they reach the store, they may have to either find any big banners advertising the sale items or guess what categories those sale items falls under and look for the appropriate aisles for those categories and then search for those sale items. Alternatively, they may have to ask a store employee where to find the sale items. This might be an inconvenient process given the fact that there are many and overlapping categories.

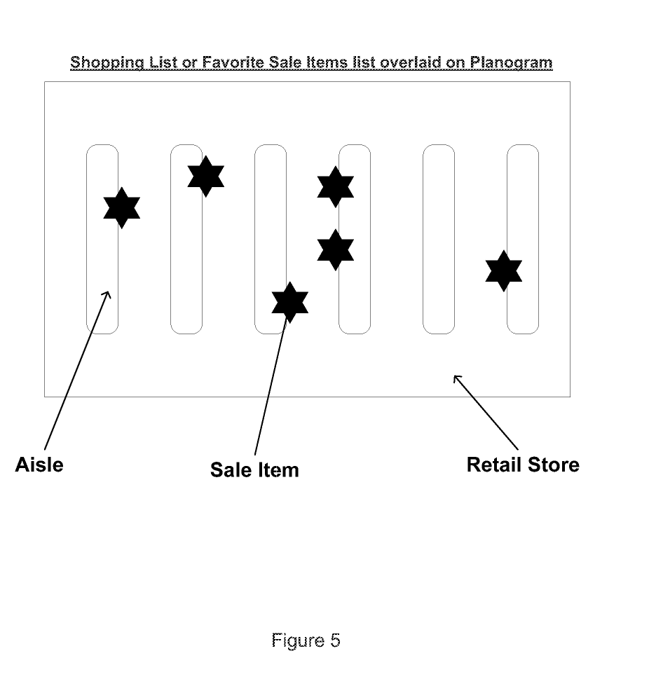

However, now when the retailer uploads the list of the store locations into the Smart phone application system such as at a server, they may add the planograms (or other types of maps) for those distinct stores, each may have their own planogram. FIG. 5 illustrates a simple planogram showing aisles of a retail store and an item for sale (which could be item associated with a coupon), according to principles of the invention. Using an application server, for example, the retailer may update the planograms for any of their stores. Thus, when a shopper enters a store with a shopping list or favorites list of sale items or coupons, they could simply see that list overlaid on the store planogram. This may eliminate the need to make any guesses or look for big signs or ask store employees for assistance. This may make the shopping experience a pleasant one for the shopper while also providing convenience.

So, in various aspect, the system may perform the steps of accepting a planogram, mapping sale items or coupon related items to the planogram, and displaying on a user's mobile device the planogram and location in the store of the item related to the coupon or sale. Moreover, a mobile device may receive an item location within a retail entity and display a map in the entity location of the item for a coupon or sale.

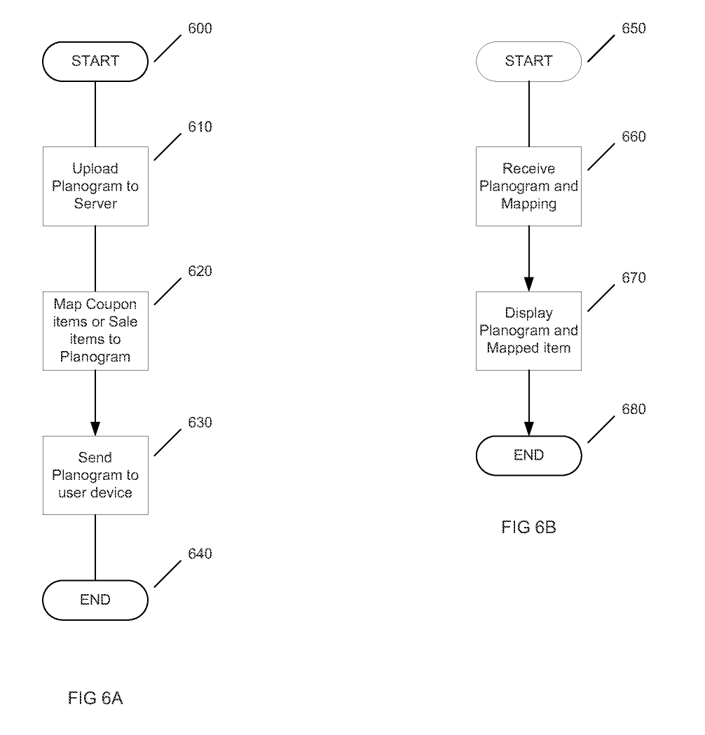

FIGS. 6A and 6B are flow diagrams showing steps of providing or receiving a planogram, the steps performed according to principles of the invention, starting at steps 600 or 650, respectively. At step 610, a retail provider may upload one or more planograms for one or more stores to a server, which might be a website. At step 620, coupon related items or sales items to the appropriate planogram. At step 630, the planogram may be sent to the user device, perhaps based on proximity of the device to a store, or upon user request. At step 640 the process may end.

Referring to FIG. 6B, at step 660, a mobile device may receive a planogram that may include mapping of items to the planogram based on coupons or sales items, for example. At step 670, the planogram and mapped items may be displayed on the mobile device showing locations of items within the retail entity. At step 680, the process may end.

The examples given above are merely illustrative and are not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the art or related fields are intended to be within the scope of the appended claims.

I claim:

1. A system comprising:
a server coordinates consumer location information with at least one location of one or more retail entities;
at least one mobile wireless electronic device in communication with the server that is configured to provide the consumer location information and configured to receive sale promotions information for the one or more retail locations including electronic coupons,
wherein the server selects the sale promotions including electronic coupons based on the proximity of the mobile wireless electronic device to the one or more retail entities, and
wherein the server is configured to provide a map of the one or more retail entities showing a location within the one or more retail entities of an item related to the electronic coupons.

2. The system of claim 1, wherein the server further selects the sale promotions including electronic coupons based on preset preferences of a consumer.

3. The system of claim 1, wherein the server is configured to receive the sale information including electronic coupons from the one or more retail entities.

4. The system of claim 1, wherein the server is configured to provide aggregated market data concerning one or more consumers associated with the at least one mobile wireless electronic device.

5. The system of claim 1, wherein the consumer location information include GPS coordinates.

6. A method of providing a sales promotion information service to mobile devices, the method comprising the steps of:
receiving a current location information from a mobile wireless electronic device;
receiving sales information including electronic coupons from one or more retail entities;
selecting sales information including an electronic coupon for at least one of the one or more retail entities based at least in part on the current location information; and
providing the sales information including the electronic coupon to the mobile wireless electronic device, including a location within the one or more retail entities.

7. The method of claim 6, wherein the selecting step includes selecting the sales information including an electronic coupon based in part on a preference associated with the mobile wireless electronic device.

8. The method of claim 7, wherein the preference is pre-established by a user of the mobile wireless electronic device.

9. The method of claim 7, wherein the preference is associated with an account established by a user associated with the mobile wireless electronic device.

10. The method of claim 6, further comprising the step of charging a fee to a customer of the service.

11. A method of providing sales information service to mobile devices, the method comprising;
receiving at a mobile device, coupon information related to an item for sale;
receiving a map of a retail entity; and
displaying the map showing the location of the item within the entity.

12. The method of claim 11, further comprising conveying information concerning the coupon to a social networking service.

13. The system of claim 1, wherein the server comprises a website.

14. The method of claim 6, further comprising conveying the sales information to a social networking service for redistribution to other members of the social networking service.
